(19) United States
(12) Patent Application Publication
(10) Pub. No.: US 2016/0092550 A1
(43) Pub. Date: Mar. 31, 2016

(54) AUTOMATED SEARCH INTENT DISCOVERY

(71) Applicant: Yahoo!, Inc., Sunnyvale, CA (US)

(72) Inventors: Reiner Kraft, Gilroy, CA (US); Uri Schonfeld, San Jose, CA (US)

(21) Appl. No.: 14/501,222

(22) Filed: Sep. 30, 2014

(51) Int. Cl. G06F 17/30

(52) U.S. Cl. CPC G06F 17/30598; G06F 17/30424

(57) ABSTRACT

A first named entity, in a first query, may be identified. A first type, of the first named entity, may be determined and a first prefix and a first postfix, associated with the first named entity in the first query, may be identified. The first prefix and the first postfix may be assigned to a first group. The first group may designate one or more prefixes and one or more postfixes as being associated with the first type. A second named entity, associated with the first prefix and the first postfix in the first group, may be identified in a second query. Responsive to the second named entity being associated with the first type, a first search intent case comprising the first prefix, the first postfix, and the first type may be added to a database.

### BACKGROUND

As new information becomes available, editors manually discover new search intent cases using query logs. Typically, an editor will pick a type (e.g., a movie) and then pick a domain where the editor subjectively believes content exists for the type (e.g., a video streaming website). The editor, using the query logs containing past searches, form a list of queries that led users to the domain (e.g., “watch awesome movie online”). The editor compiles a list of prefixes and postfixes associated with the type from the list of queries. The editor manually examines the list of prefixes and postfixes to infer user intent. The inferences of user intent are used to generate user intent cases. Generally, one editor requires multiple days to generate a user intent case for a given type. Further, different editors may generate different user intent cases for a given type, indicating that an editor's judgment may be subjective, and that user intent cases may be overlooked due to the subjective nature of the user intent case generation process.

### SUMMARY

In accordance with the present disclosure, a first named entity, in a first query generated by a first user, may be identified. A first type of the first named entity may be determined A first prefix and a first postfix, associated with the first named entity in the first query, may be identified. The first prefix and the first postfix may be associated as a first pair, and assigned to a first group. The first group may designate one or more prefixes and one or more postfixes associated as pairs as being associated with the first type. Responsive to the first prefix and/or the first postfix being associated with a threshold number of types, the first pair may be removed from the first group. A second named entity, associated with the first prefix and the first postfix in the first group, may be identified in a second query generated by a second user. Responsive to the second named entity not comprising the first type, the first prefix and the first postfix may be removed from the first group. Responsive to the second named entity being associated with the first type, a first search intent case comprising the first prefix, the first postfix, and the first type may be added to a database. Responsive to identifying a duplicate search intent case in the database, where the duplicate search intent case is the same as the first search intent case, the duplicate search intent case may be removed from the database. Responsive to determining that the first search intent case and named entities of the first type are not logically associated, the first search intent case may be removed from the database.

A first domain of a first search result may be selected by the first user in response to the first query. The first domain may be associated with the first search intent case. The first search intent case may be assigned to at least one of a first domain group, a first pre and post fix group, or a first type group. The first domain group may designate one or more search intent cases as being associated with the first domain. The first pre and post fix group may designate one or more search intent cases as being associated with the first prefix and the first postfix. The first type group may designate one or more search intent cases as being associated with the first type.

At least one of the first domain, the first prefix and the first postfix, or the first type of the first search intent case may be compared to existing search intent cases in the database. The existing search intent cases may comprise an existing domain, an existing prefix and postfix, and an existing first type. A second intent case may be created using at least one of the existing domain, the existing prefix and postfix, the existing first type, the first domain, the first prefix and first postfix, or the first type. A first verb in at least one of the first prefix or the first postfix associated with the first type may be identified. Responsive to the first verb satisfying a type cohesiveness metric, the first verb may be assigned to the first type within the database.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of automated search intent discovery.

FIG. 5A is a component block diagram illustrating an example system for automated search intent discovery, where a first intent case is generated.

FIG. 5B is a component block diagram illustrating an example system for automated search intent discovery, where a first intent case is not generated.

FIG. 5C is a component block diagram illustrating an example system for automated search intent discovery using an example query, where a first intent case is generated.

FIG. 5D is a component block diagram illustrating an example system for automated search intent discovery, where a first domain is identified.

FIG. 5E is a component block diagram illustrating an example system for automated search intent discovery using an example query, where a first domain is identified.

FIG. 6A is a component block diagram illustrating an example system for generating a second intent case using automated search intent discovery.

FIG. 6B is a component block diagram illustrating an example system for removing a duplicate intent case from a database.

FIG. 6C is a component block diagram illustrating an example system for determining that a first search intent case is logical.

FIG. 7 is a component block diagram illustrating an example system for identifying a first verb associated with a first type.

FIG. 8 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

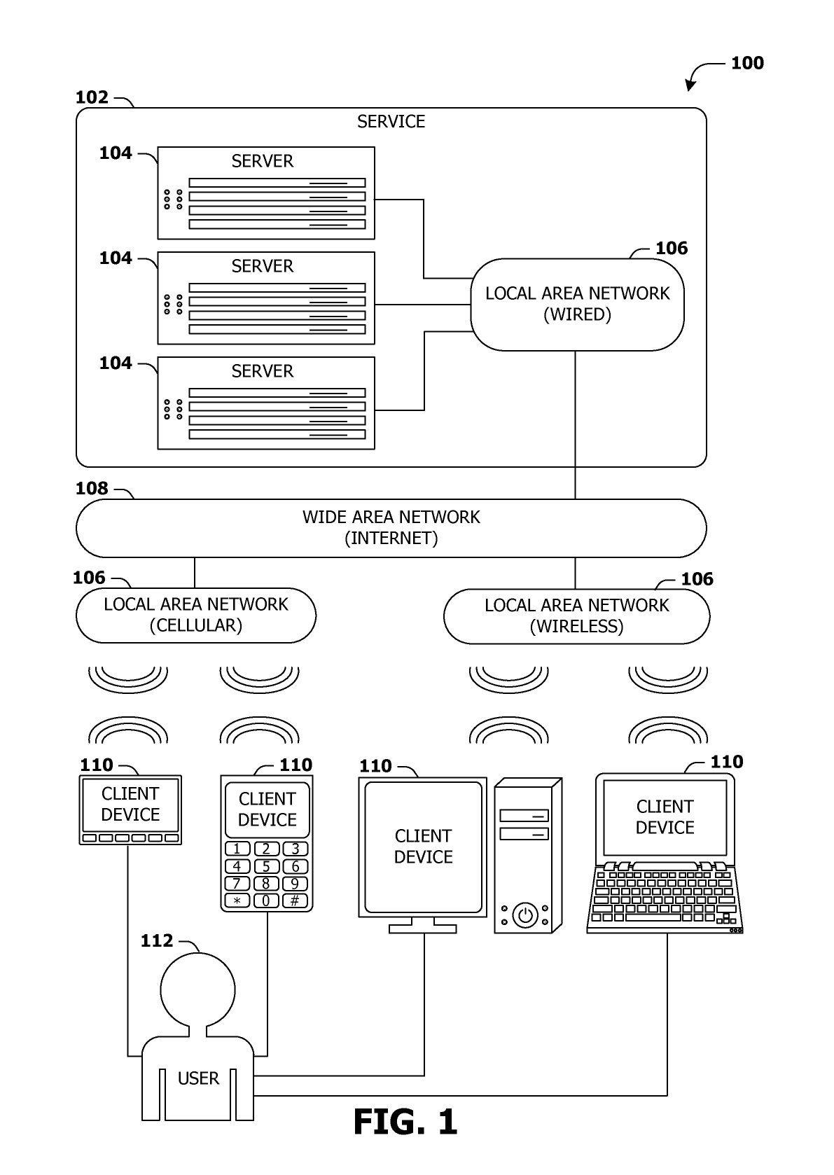

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

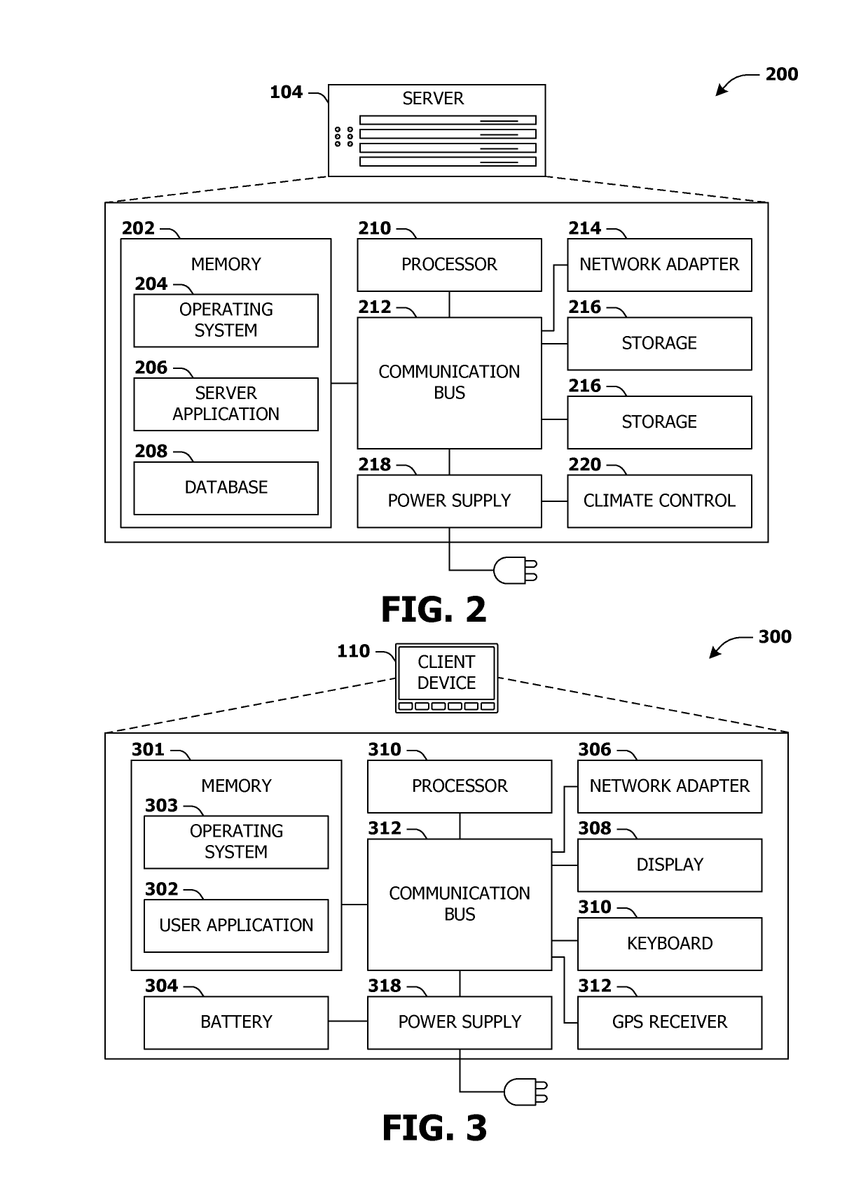

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more systems and/or techniques for automated search intent discovery are provided herein. Information and technology are constantly changing. Currently, an editor requires several days to generate a new search intent case and to associate the new search intent case with an appropriate domain (e.g., used to take a user to a website that is pertinent to the user's search). However, as new information becomes available, the user may generate a query containing a prefix, a first named entity, and a postfix to learn more. In an example, if a famous actress, Katy Famous, who is associated with a type (e.g., an actress type) becomes a singer, it would take several days for an editor to add new search intent cases associating Katy Famous with a new type (e.g., a singer type). Users may immediately, upon learning about Katy Famous's upcoming song, generate queries of “Listen to Katy Famous Song” or “download new Katy Famous music.” Because neither songs or music are currently associated in a user intent case with Katy Famous, the user may likely be sent to a domain more appropriate for an actress than a singer (e.g., to a streaming video website rather than a website offering the user the opportunity to listen to and/or buy a song).

The ability to automatically identify a user query with new associations, such as associating Katy Famous with singer, decreases the time between new information becoming available and search results yielding domains appropriate for user queries pertaining to the new information (e.g., as opposed to a substantially longer time period for the manual editor process to identify the new association). Further, a user who is taken to an inappropriate domain may become frustrated that their query did not yield a usable result (e.g., companies will lose business and/or good will).

The editor's judgment may be subjective, rather than empirical. The editor's subjectivity may cause user intent cases to be overlooked. In an example, where the user is searching for “Katy Famous clothes” and chooses a domain that comprises a website that shows pictures, the editor may conclude that the user's intent was to view pictures of Katy Famous. In actuality, the user was searching for a new line of clothing that Katy Famous developed. The editor's conclusion overlooks the Katy Famous clothing line. The automated intent discovery process negates the subjective element of the editor, and empirically determines associations between prefixes, postfixes, named entities, types, and domains. The automated intent discovery process may identify Katy Famous as a clothing designer, and generate a user intent case identifying prefixes and postfixes associated with both Katy Famous and clothing designers.

Additionally, the ability to automatically generate new search intent cases may reduce an editor's work load. The reduced work load decreases the number of hours the editor is required to work. Reducing the number of hours that the editor is required to work saves the editor's employer money.

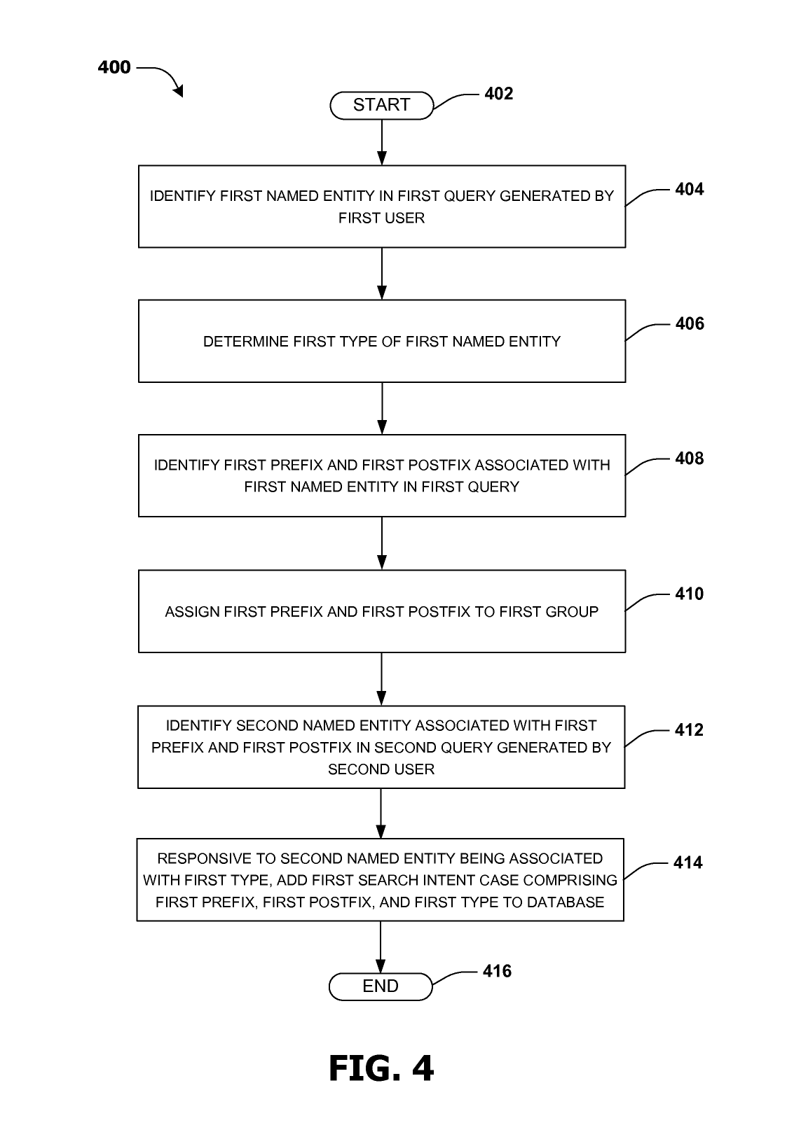

An embodiment of automated search intent discovery is illustrated by an example method 400 of FIG. 4. At 402, the method starts. At 404, a first named entity in a first query generated by a first user may be identified. The first query may contain a first prefix, the first named entity, and a first postfix. In an example, the first query may be “watch new Katy Famous movie.” Katy Famous may be identified as the first named entity. At 406, a first type of the first named entity may be determined A type of a named entity may comprise one or more general categories that may apply to the named entity. In an example, where the named entity is Sally Singer and Sally Singer is a singer, the first type for Sally Singer may be determined to be a singer type. The first named entity may be determined to comprise one or more types. At 408, the first prefix and the first postfix, associated with the first named entity in the first query, may be identified. The first prefix may comprise words preceding the first named entity. Where there are not words preceding the first named entity, the first prefix may be blank. The first postfix may comprise words succeeding the first named entity. Where there are not words succeeding the first named entity, the first postfix may be blank. Where both the first prefix and the first postfix are present, the first prefix may be associated with the first postfix to comprise a first pair. In the example of the first query “watch new Katy Famous movie”, “watch new” comprises the first prefix and “movie” comprises the first postfix.

At 410, the first pair may be assigned to a first group. The first group may designate one or more prefixes and one or more postfixes, associated as pairs, as being associated with the first type. In an example where “watch new” comprises the first prefix and “movie” comprises the first postfix, “watch new” and “movie” may be assigned to the first group, and thus are associated with the first type (e.g., an actor type). Responsive to the first prefix and/or the first postfix being associated with a threshold number of types, the first pair may be removed from the first group. The threshold number of types may determine how many different types may be associated with the first pair. In an example, the threshold number of types may be determined such that the first prefix or first postfix is not generic. In an example, such as where the first prefix is “what is” the prefix may be generic because “what is” may be applied to too many types to be a valuable metric for mining user intent. For example, “what is” is ambiguous, as it may be applied to unrelated searches such as a search having to do with mammals (e.g., what is an elephant), a search having to do with money (e.g., what is currency), a search having to do with disease (e.g., what is cancer), etc.

At 412, a second named entity, associated with the first prefix and the first postfix, may be identified in a second query generated by a second user. In an example, the first user and the second user may be the same user. In another example, the first user may be different than the second user. A query log, comprising one or more queries generated by one or more users, may be searched for the second query associated with the first prefix and the first postfix. In an example, where “watch new” comprises the first prefix and “movie” comprises the first postfix, the second query may be “watch new Larry Legendary movie.” At 414, responsive to the second named entity being associated with the first type, a first search intent case, comprising the first pair, comprising the first prefix and the first postfix, and the first type, may be added to a database. In an example, where the second query is “watch new Larry Legendary movie”, if Larry Legendary is associated with the first type (e.g., the actor type), then the first search intent case may comprise the first prefix (e.g., watch new), the first postfix (e.g., movie), and the first type (e.g., the actor type). If Larry Legendary is not associated with the first type (e.g., Larry Legendary is not an actor) then the first prefix and the first postfix are removed from the first group.

In an example, prior to adding the first intent case to the database, a third named entity having the first type is identified in a third query generated by a third user. The third user, the second user, and/or the first user may be the same or different users. Responsive to the third named entity being associated with the first prefix and the first postfix, a confidence score associated with the first search intent case may be increased. In an example, a fourth named entity associated with the first prefix and the first postfix in a fourth query may be identified. Responsive to the fourth named entity being associated with the first type, the confidence score associated with the first search intent case may be further increased. In an example, prior to adding the first intent case to the database, a threshold confidence score of the first intent case may be reached. In this way, a plurality of user queries may be evaluated for automated search intent discovery. At 416, the method ends.

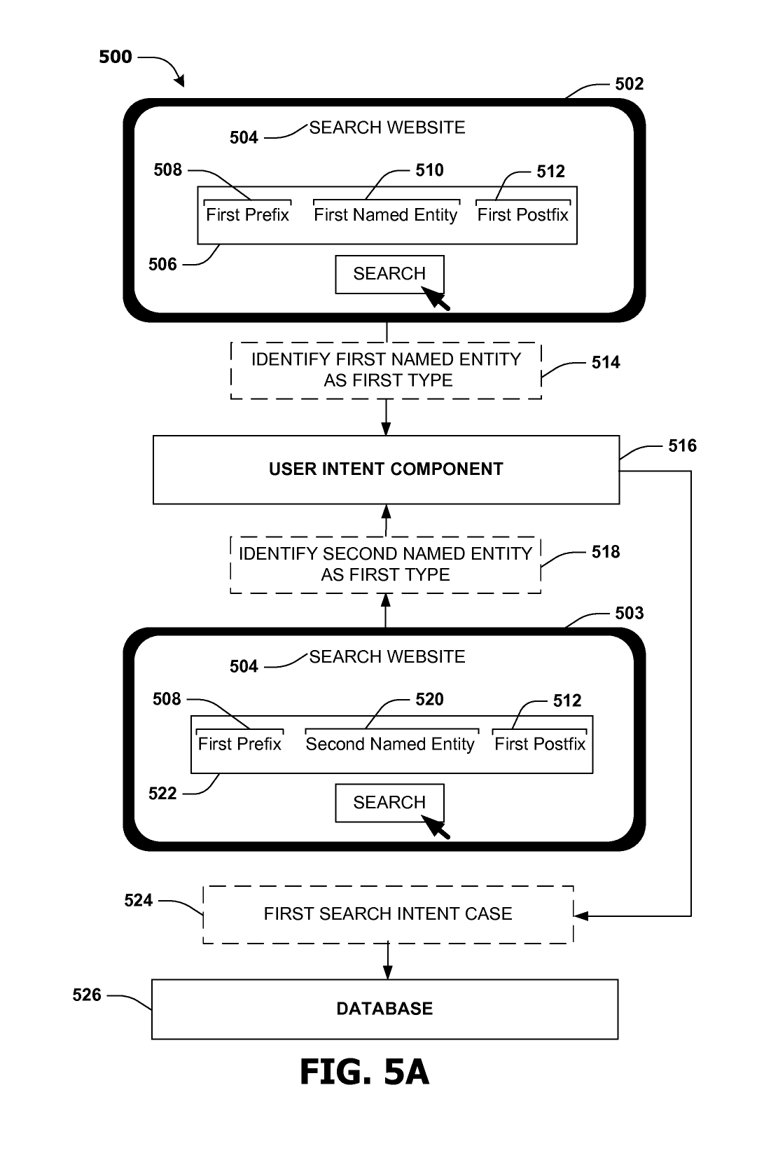

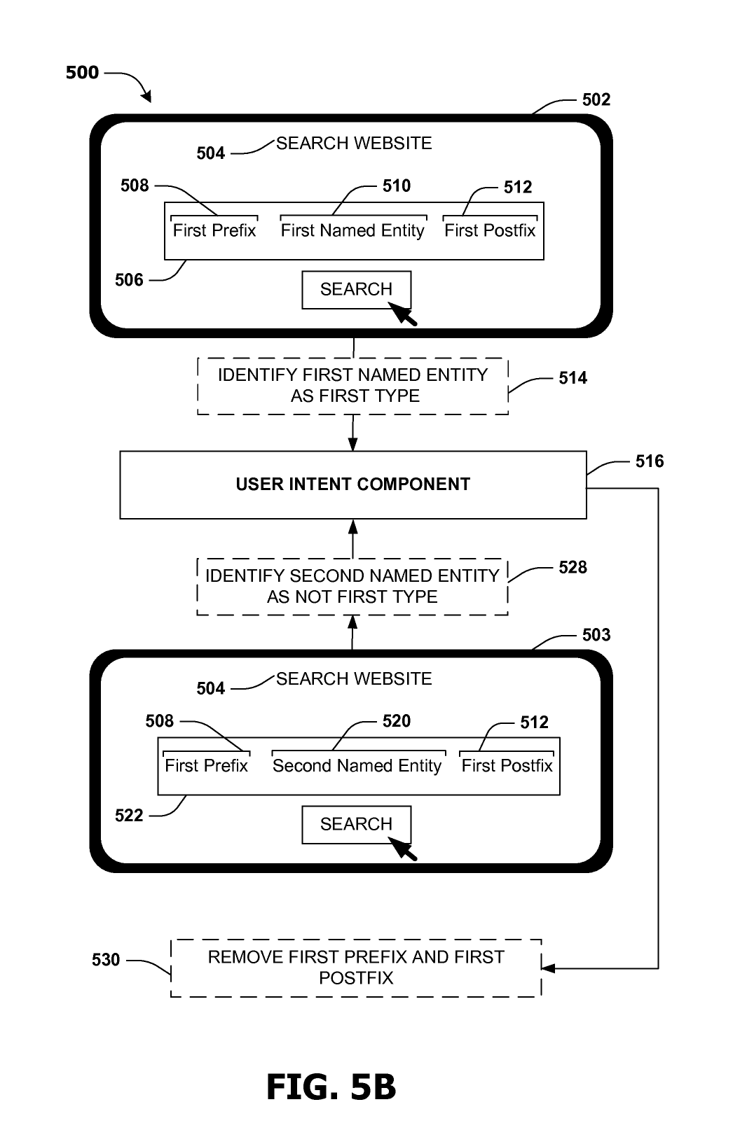

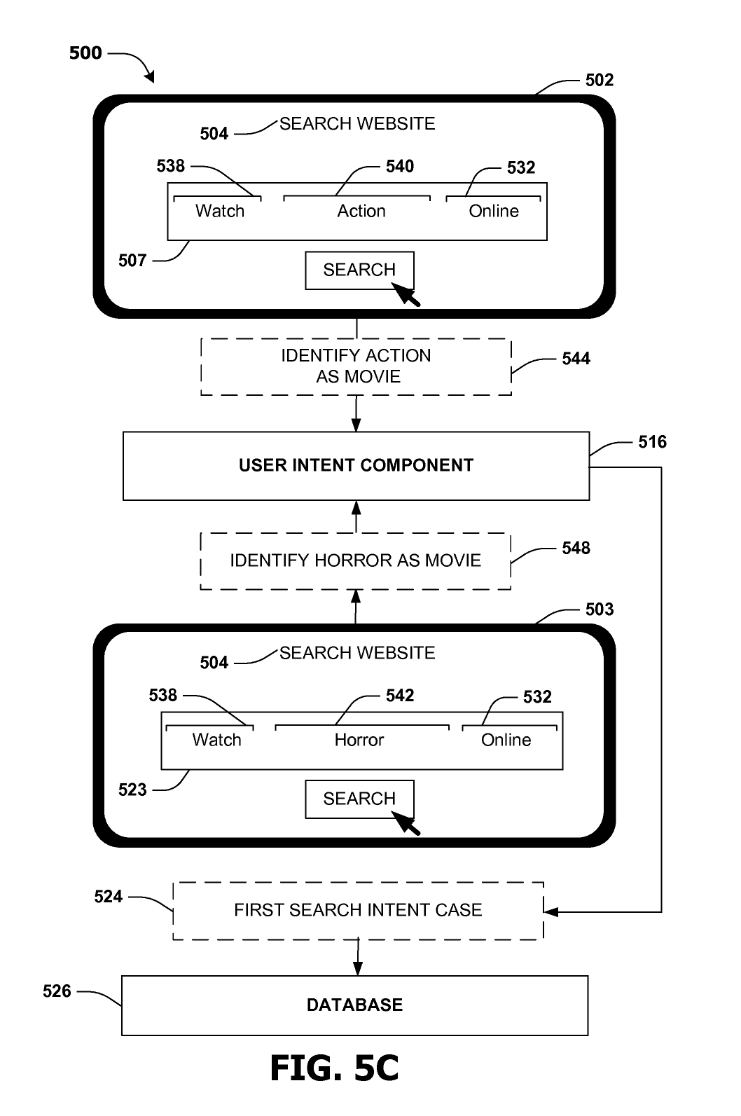

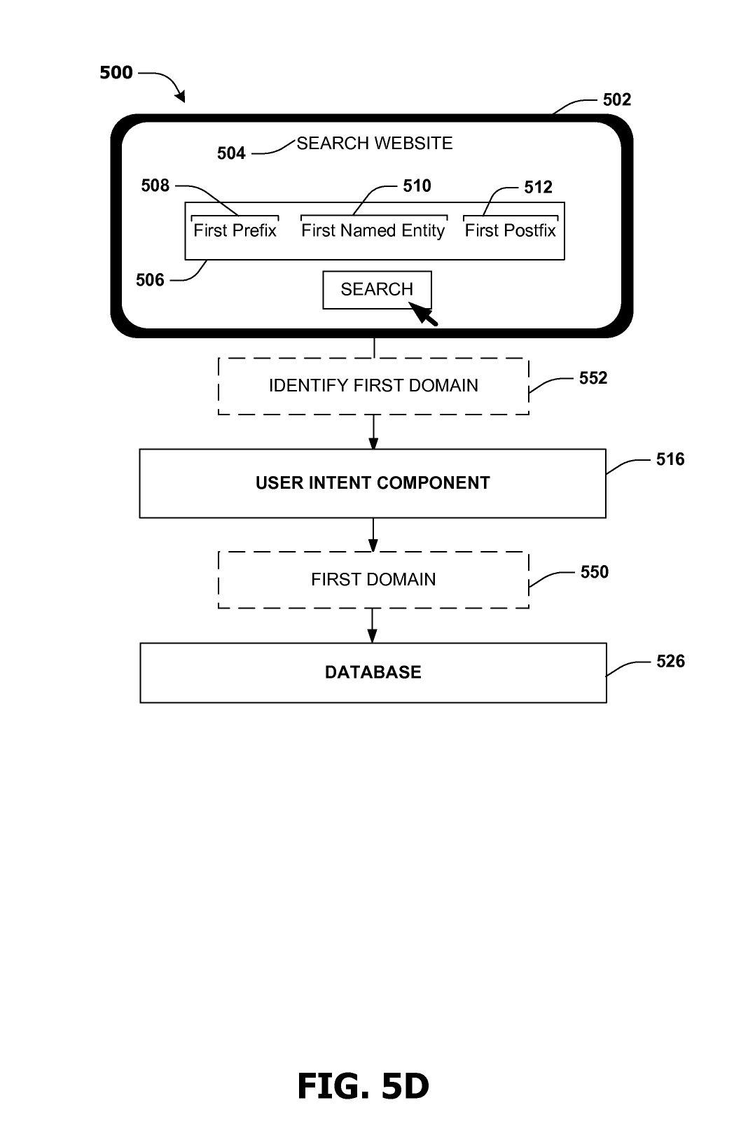

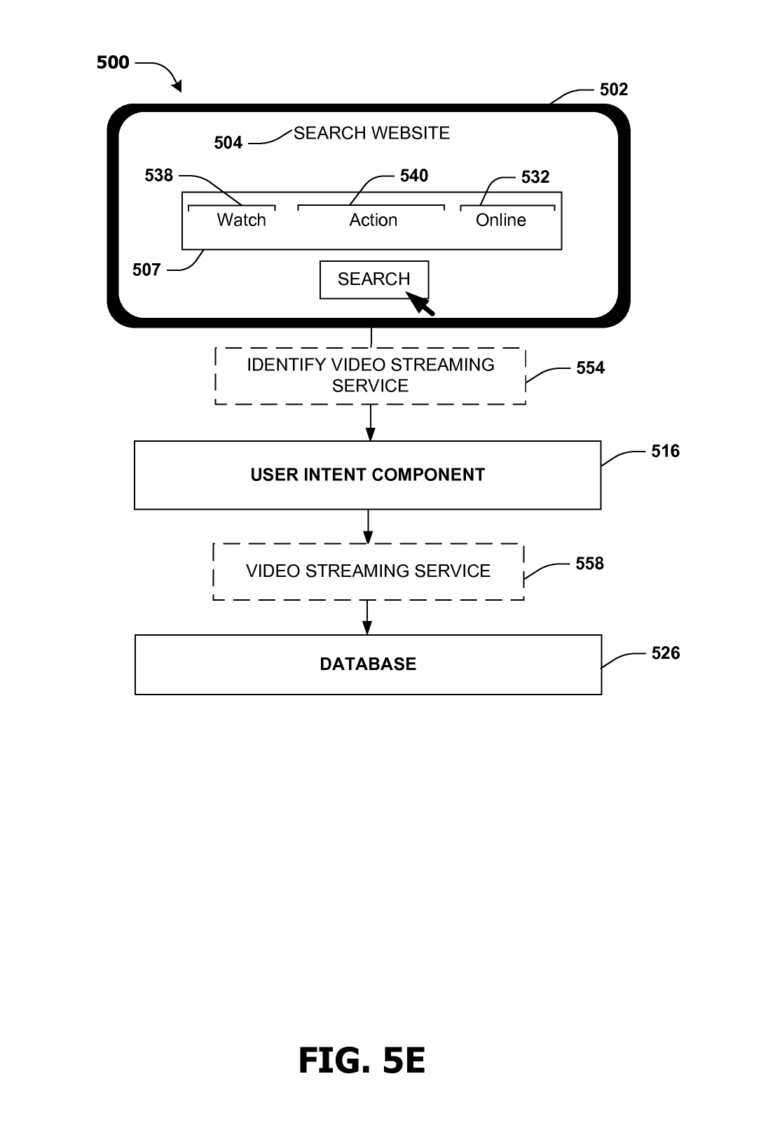

FIGS. 5A-5E illustrate a system 500, comprising a user intent component 516 for automated search intent discovery. FIG. 5A illustrates the user intent component 516 generating a first search intent case 524. A first user on a first client device 502 may generate a first query 506 on a search website 504. The first query 506 may comprise a first prefix 508, a first named entity 510, and a first postfix 512. In an example, the first query 506 may be received by the user intent component 516. The user intent component 516 may identify 514 the first named entity 510 of the first query 506 as being associated with the first type. The user intent component 516 may associate the first prefix 508 and the first postfix 512 together as a first pair. The user intent component 516 may assign the first prefix 508 and the first postfix 512 to a first group. In an example, the first group may designate one or more prefixes and one or more postfixes, associated as pairs, as being associated with the first type.

A second user on a second client device 503 may generate a second query 522 on the search website 504. The first user and the second user may be the same or different users. The first client device 502 and the second client device 503 may be the same or different devices. The second query 522 may comprise the first prefix 508, a second named entity 520, and the first postfix 512. In an example, the user intent component 516 may receive the second query 522. The user intent component 516 may identify 518 the second named entity 520 of the second query 511 as being associated with the first type. Responsive to the user intent component 516 designating the second named entity 520 as being associated with the first type, the user intent component 516 may add the first search intent case 524 to a database 526. The first search intent case 524 may comprise the first pair, comprising the first prefix 508 and the first postfix 512, and the first type. In an example, the user intent component 516 utilizes a user centric intent taxonomy (UCIT).

FIG. 5B illustrates the user intent component 516 not generating the first search intent case 524. The first user on the first client device 502 may generate the first query 506 on the search website 504. The first query 506 may comprise the first prefix 508, the first named entity 510, and the first postfix 512. The user intent component 516 may receive the first query 506. The user intent component 516 may identify 513 the first named entity 510 of the first query 506 as the first type. The user intent component 516 may associate the first prefix 508 and the first postfix 512 together as the first pair. The user intent component 516 may assign the first prefix 508 and the first postfix 512 to the first group.

In an example, the second user on the second client device 503 may generate the second query 522 and enter the second query 522 on the search website 504. The second query 522 may comprise the first prefix 508, the second named entity 520, and the first postfix 512. The user intent component 516 may receive the second query 522. The user intent component 516 may identify 528 the second named entity 520 of the second query 522 as not being associated with the first type (e.g., where the first type comprises a movie type and the second named entity 520 is cancer, which is a disease type). Responsive to the user intent component 516 designating the second named entity 520 as not being associated with the first type, the user intent component 516 may remove 530 the first pair, comprising the first prefix 508 and the first postfix 512, from the first group.

FIG. 5C illustrates the user intent component 516 generating the first search intent case 524 from an example first query 507 and an example second query 523. In an example, the example first query 507, input by the first user, may comprise watch 538 as the first prefix, action 540 as the first named entity, and online 532 as the first postfix. The user intent component 516 may receive the example first query 507. The user intent component 516 may identify 544 Action 540 as being associated with the first type, such as a movies type. The user intent component 516 may associate watch 538 and online 532 together as the first pair. The user intent component 516 may assign the first pair comprising watch 538 and online 532 to the first group.

In an example, the example second query 523, input by the second user, may comprise watch 538 as the first prefix 508, Horror 542 as the second named entity 520, and online 532 as the first postfix 512. In an example, the example second query 523 may be received by the user intent component 516. The user intent component 516 may identify 548 Honor 542 as being associated with the movies type, which comprises the first type. Responsive to the user intent component 516 designating Honor 542 as being associated with the movies type, the user intent component 516 may add the first search intent case 524 to the database 526. The first user intent case 524 may comprise the first pair, comprising watch 538 and online 532, and the movies type.

The ability to automatically identify a user query with new associations decreases the time between new information becoming available and search results yielding domains appropriate for user queries pertaining to the new information. For example, when technology first became available to watch movies online, rather than by tape or digital video disk, the ability to automatically identify a user query comprising watch 538 and online 532 with the movies type would more quickly take users to a website that streams videos online, than would be available absent the ability to automatically identify a user query.

FIG. 5D illustrates the user intent component 516 generating a first domain 550. The first user may initiate a first search of the first query 506. The first search of the first query 506 may result in one or more domains. The user intent component 516 may identify 552 the first domain 550 of a first search result of the first search selected by the first user in response to the first query 506. In an example, the first domain 550 is derived from a website that is pertinent to the first search generated by the first user. The user intent component 516 may input the first domain 550 into the database 526. In an example, the first intent case 524 may comprise the first pair, comprising the first prefix 508 and the first postfix 512, the first type, and the first domain 550.

FIG. 5E illustrates the user intent component 516 generating an example of the first domain 550. The first user may initiate the first search of the example first query 507. The first search of the example first query 507 may result in one or more domains. The user intent component 516 may identify 554 the first domain 550 as a video streaming service 558. In an example, the video streaming service 558 may comprise a website that is pertinent to the example first query 507. The user intent component 516 may create an association between the video streaming service 558 and the first search intent case 524 within the database 526. In an example, the first intent case 524 may comprise the first pair, comprising watch 538 and online 532, and the movies type (e.g. the first type) associated with the video streaming service 558.

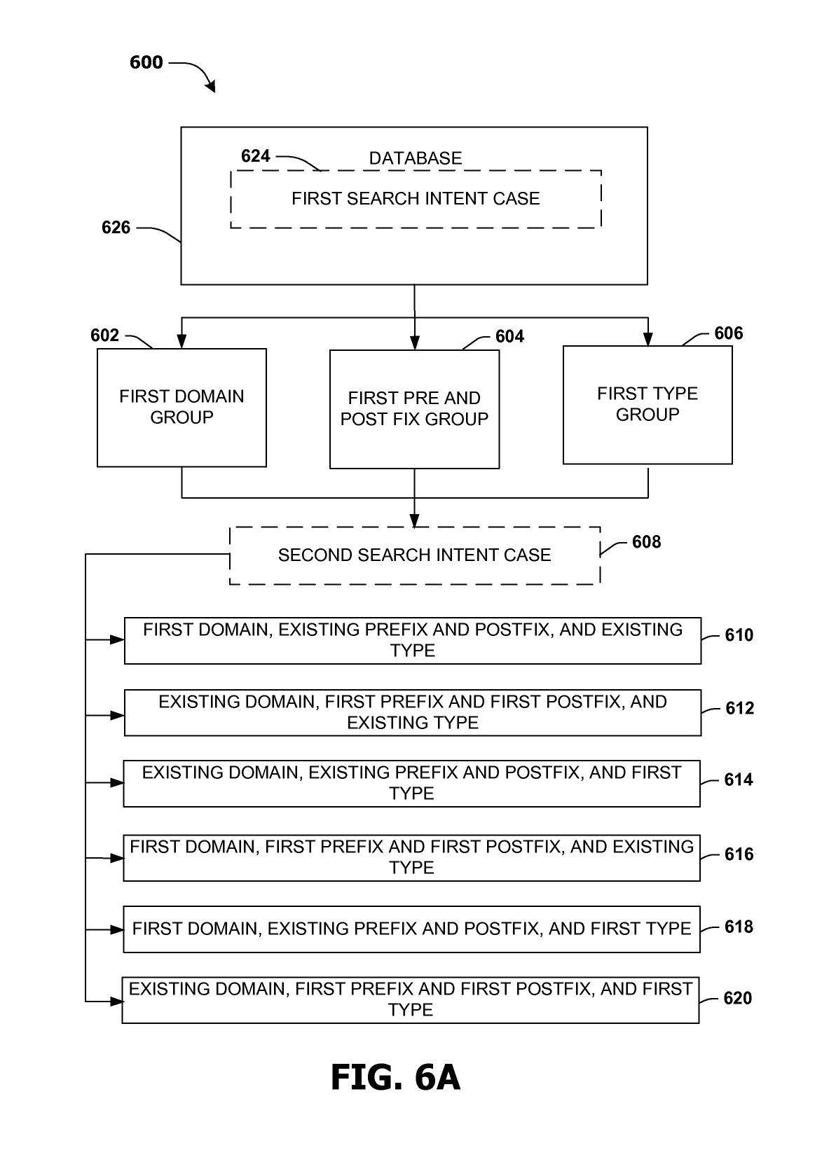

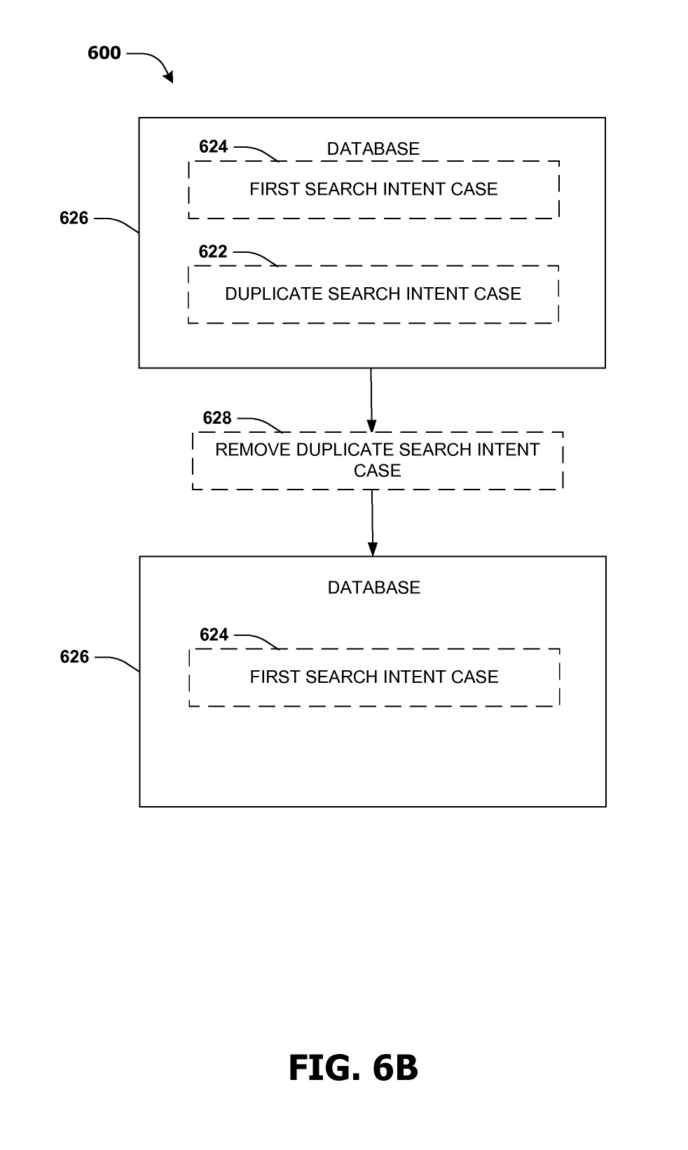

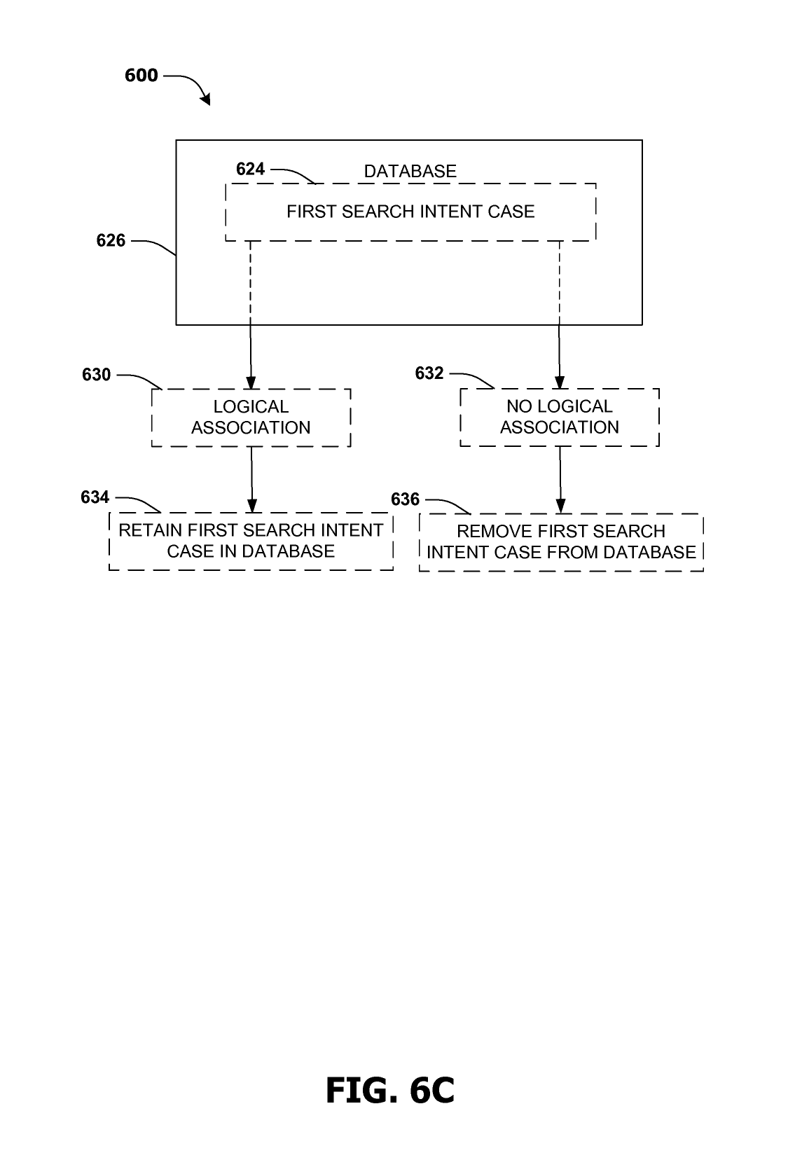

FIGS. 6A-6C illustrate a system 600, comprising a mechanism for utilizing a database 626 and identifying defects in the database 626 pertaining to automated search intent discovery. FIG. 6A illustrates an example system for creating a second search intent case 608. A first search intent case 624, added to the database 626, may be assigned to at least one of a first domain group 602, a first pre and post fix group 604, or a first type group 606. In an example, the first domain group 602 may designate one or more search intent cases as being associated with a first domain (e.g., where the one or more search intent cases, having to do with watching movies, are associated with a video streaming service). An existing domain may be in the first domain group 602. In an example, the first pre and post fix group 604 may designate one or more search intent cases as being associated with a first pair comprising a first prefix and a first postfix (e.g., where the one or more search intent cases, having to do with watching movies, are associated with watch as a prefix and online as a postfix). An existing pair, comprising an existing prefix and postfix, may be in the first pre and post fix group 604. In an example, the first type group 606 may designate one or more search intent cases as being associated with a first type (e.g., where the one or more search intent cases, having to do with watching movies, are associated with a movies type). An existing type may be in the first type group 606.

In an example, the second search intent case 608 comprises the first domain, the existing pair, comprising the existing prefix and postfix, and the existing type 610. In an example, the second search intent case 608 comprises the existing domain, the first pair, comprising the first prefix and first postfix, and the existing type 612. In an example, the second search intent case 608 comprises the existing domain, the existing pair, and the first type 614. In an example, the second search intent case 608 comprises the first domain, the first pair, and the existing type 616. In an example, the second search intent case 608 comprises the first domain, the existing pair, and the first type 618. In an example, the second search intent case 608 comprises the existing domain, the first pair, and the first type 620.

The ability to further filter the first search intent case 624 by integrating existing components (e.g., the existing domain, the existing pair, the existing type, etc) with components of the first search intent case 624 (e.g., the first domain, the first pair, the first type, etc) to create the second search intent case 608, increases a confidence score of the second search intent case 608 (e.g., increases the likelihood that search intent cases are logically associated and useful to users).

FIG. 6B illustrates an example system for removing a duplicate search intent case 622 from the database 626. In an example, the duplicate search intent case 622 may be the same as the first search intent case 624. A duplicate search may be performed in the database 626. Responsive to identifying that the duplicate search intent case 622 is in the database 626, the duplicate search intent case 622 may be removed 628 from the database 626.

By removing the duplicate search intent case 622 from the database 626 computing power and/or storage is conserved. Computing power may be conserved by reducing the number of search intent cases that a search of a query may parse through to generate search results. Duplicate cases would increase the number of search intent cases that a search of a query may parse through.

FIG. 6C illustrates an example system for determining that the first search intent case 624 comprises a logical association 630. In an example, after the first search intent case 624 is added to the database 626, the first pair, comprising the first prefix and the first postfix, and the first type may be assessed to determine if the first pair and the first type are logically associated. The first type and the first domain may be assessed to determine if the first type and the first domain are logically associated.

In an example, where the first search intent case comprises “watch” as the first prefix, “online” as the first postfix, and “movie type” as the first type, there may be a logical association 630, because movies are watched. In an example, the logical association 630 between “watch,” “online,” and “movie type” may be determined by a high number and/or frequency of queries in a form “watch <some movie name> online ” In an example, a number and/or frequency of queries may be determined to be low and/or high relative to a total frequency of the first pair, such as “watch” and “online,” and/or a total frequency of the first named entity (e.g., some movie name) in search queries.

In an example, where the first search intent case comprises “watch” as the first prefix, “online” as the first postfix, and “book type” as the first type, there may be no logical association 632, because books are not watched. In an example, no logical association 632 between “watch,” “online,” and “book type” may be determined based upon a low number and/or frequency of queries in a form “watch <some book name> online” relative to a number and/or frequency of the first pair in a query pattern and/or a number and/or frequency of other queries relating to <some book name>.

In an example, a low number and/or frequency of search queries may comprise less than about 5% of queries comprising the first pair and the first named entity, relative to a total number of queries comprising the first pair and/or <some book name>. In an example, the high number and/or frequency of search queries may comprise greater than about 20% of queries comprising the first pair and <some movie name> relative to the total number of queries comprising the first pair and/or <some movie name>.

Responsive to determining that no logical association 632 exists, the first search intent case 624 may be removed 636 from the database 626. Responsive to determining that the logical association 630 exists, the first search intent case 624 may be retained 634 in the database 626.

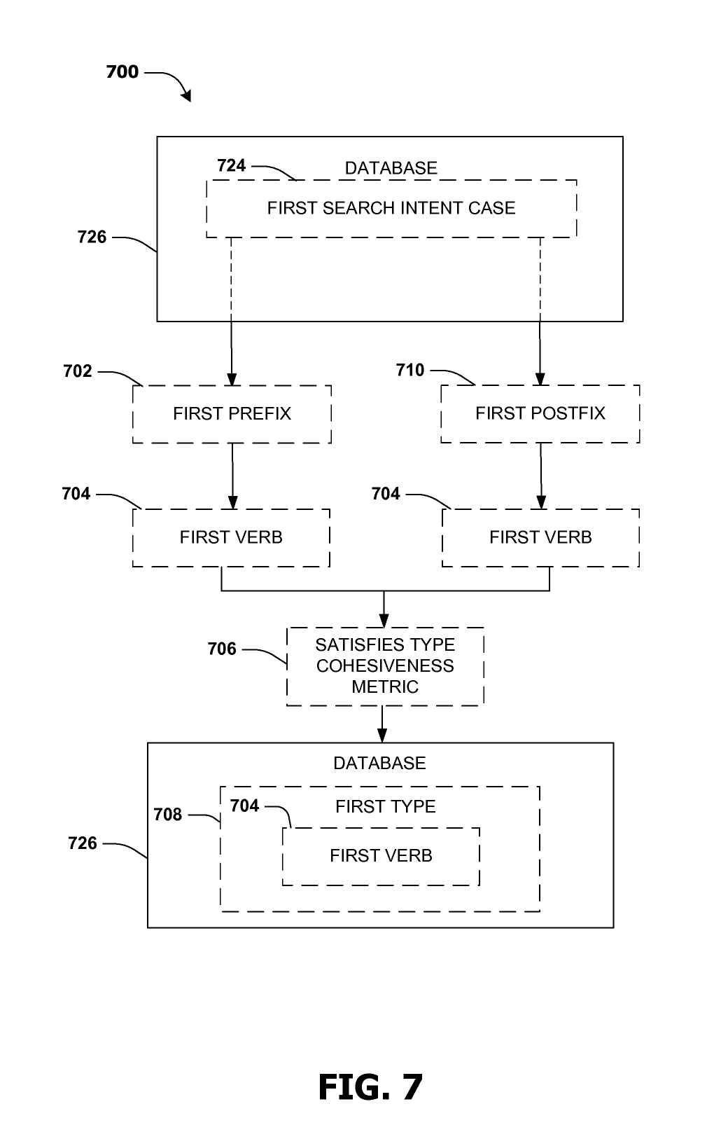

FIG. 7 illustrates an example system for identifying a first verb 704 associated with a first type 708. After a first search intent case 724, comprising a first prefix 702, a first postfix 710, the first type 708, and a first domain is added to a database 726, the first verb 704 may be identified in at least one of the first prefix 702, or the first postfix 710. In an example, where the first prefix 702 comprises “see new” and the first postfix 710 comprises “online,” the first verb 704 may be identified as “see.” Responsive to the first verb 704 satisfying a type cohesiveness metric 706, the first verb 704 is assigned to the first type 708 within the database 726. The type cohesiveness metric 706 may be satisfied when the first verb 704 is associated with a number of types below a type threshold (i.e., the first verb 704 is not ubiquitous, for example where the first verb 704 is “is”). Responsive to the first verb 704 not satisfying the type cohesiveness metric 706, the first verb 704 is not assigned to the first type 708 within the database 726.

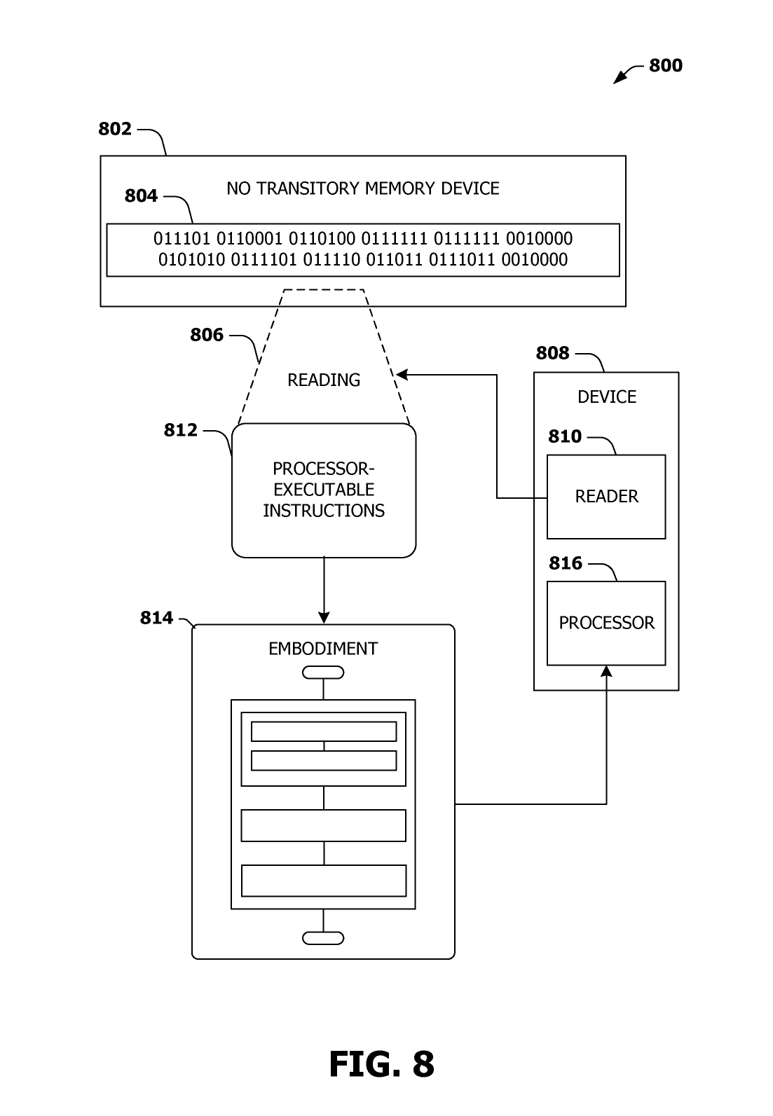

FIG. 8 is an illustration of a scenario 800 involving an example nontransitory memory device 802. The nontransitory memory device 802 may comprise instructions that when executed perform at least some of the provisions herein. The nontransitory memory device 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 802 stores computer-readable data 804 that, when subjected to reading 806 by a reader 810 of a device 808 (e.g., a read head of a hard disk drive, or a read operation invoked on a solid-state storage device), express processor-executable instructions 812. In some embodiments, the processor-executable instructions, when executed on a processor 816 of the device 808, are configured to perform a method, such as at least some of the example method 400 of FIG. 4, for example. In some embodiments, the processor-executable instructions, when executed on the processor 816 of the device 808, are configured to implement a system, such as at least some of the example system 500 of FIGS. 5A-5E, at least some of the example system 600 of FIGS. 6A-6C, and/or at least some of the example system 700 of FIG. 7 for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method of automated search intent discovery, comprising:
identifying a first named entity in a first query;
determining a first type of the first named entity;
identifying a first prefix and a first postfix associated with the first named entity in the first query;
assigning the first prefix and the first postfix to a first group, the first group designating one or more prefixes and one or more postfixes as being associated with the first type;
identifying a second named entity associated with the first prefix and the first postfix in a second query; and
responsive to the second named entity being associated with the first type, adding a first search intent case comprising the first prefix, the first postfix, and the first type to a database.

2. The method of claim 1, comprising:
identifying a first domain of a first search result selected by a first user, associated with the first search query, in response to the first query.

3. The method of claim 2, comprising:
assigning the first search intent case to at least one of:
a first domain group, the first domain group designating one or more search intent cases as being associated with the first domain;
a first pre and post fix group, the first pre and post fix group designating one or more search intent cases as being associated with the first prefix and the first postfix; or
a first type group, the first type group designating one or more search intent cases as being associated with the first type.

4. The method of claim 1, comprising:
comparing at least one of the first domain, the first prefix and the first postfix, or the first type of the first search intent case to existing search intent cases in the database, the existing search intent cases comprising an existing domain, an existing prefix and postfix, and an existing first type; and
creating a second search intent case comprising at least one of:
the first domain, the existing prefix and postfix, and the existing type;
the existing domain, the first prefix and first postfix, and the existing type;
the existing domain, the existing prefix and postfix, and the first type;
the first domain, the first prefix and first postfix, and the existing type;
the existing domain, the first prefix and first postfix, and the first type; or
the first domain, the existing prefix and postfix, and the first type.

5. The method of claim 1, comprising:
responsive to the second named entity not comprising the first type, removing the first prefix and the first postfix from the first group.

6. The method of claim 1, comprising at least one of:
responsive to the first prefix being associated with a threshold number of types, removing the first prefix from the first group; or responsive to the first postfix being associated with the threshold number of types, removing the first postfix from the first group.

7. The method of claim 1, comprising:
responsive to identifying a duplicate search intent case in the database, where the duplicate search intent case is the same as the first search intent case, removing the duplicate search intent case from the database.

8. The method of claim 1, comprising:
responsive to determining that the first search intent case and named entities of the first type are not logically associated, removing the first search intent case from the database.

9. The method of claim 1, comprising:
identifying a first verb in at least one of the first prefix or the first postfix associated with the first type.

10. The method of claim 9, comprising:
responsive to the first verb satisfying a type cohesiveness metric, assigning the first verb to the first type within the database.

11. A system for automated search intent discovery, comprising:
a user intent component configured to:
determine a first type of a first named entity in a first query;
identify a first prefix and a first postfix associated with the first named entity in the first query;
assign the first prefix and the first postfix to a first group, the first group designating one or more prefixes and one or more postfixes as being associated with the first type;
identify a second named entity associated with the first prefix and the first postfix in a second query; and
responsive to the second named entity being associated with the first type, add a first search intent case comprising the first prefix, the first postfix, and the first type to a database.

12. The system of claim 11, the user intent component configured to:
identify a first domain of a first search result selected by a first user, associated with the first query, in response to the first query.

13. The system of claim 11, the user intent component configured to:
assign the first search intent case to at least one of:
a first domain group, the first domain group designating one or more search intent cases as being associated with the first domain;
a first prefix/postfix group, the first prefix/postfix group designating one or more search intent cases as being associated with the first prefix and the first postfix; or
a first type group, the first type group designating one or more search intent cases as being associated with the first type.

14. The system of claim 11, the user intent component configured to:
comparing at least one of the first domain, the first prefix and the first postfix, or the first type of the first search intent case to existing search intent cases in the database, the existing search intent cases comprising an existing domain, an existing prefix and postfix, and an existing first type; and
creating a second search intent case comprising at least one of:
the first domain, the existing prefix and postfix, and the existing type;
the existing domain, the first prefix and first postfix, and the existing type;
the existing domain, the existing prefix and postfix, and the first type;
the first domain, the first prefix and first postfix, and the existing type;
the existing domain, the first prefix and first postfix, and the first type; or
the first domain, the existing prefix and postfix, and the first type.

15. The system of claim 11, the user intent component configured to:
responsive to the second named entity not comprising the first type, remove the first prefix and the first postfix from the first group.

16. The system of claim 11, the user intent component configured to:
responsive to identifying a duplicate search intent case in the database, where the duplicate search intent case is the same as the first search intent case, remove the duplicate search intent case from the database.

17. The system of claim 11, the user intent component configured to:
identify a first verb in at least one of the first prefix or the first postfix associated with the first type; and
responsive to the first verb satisfying a type cohesiveness metric, assign the first verb to the first type within the database.

18. A non-transitory computer readable medium comprising computer executable instructions that when executed by a processor perform a method for automated search intent discovery, comprising:
grouping a first type of a first named entity within a first query, a first prefix within the first query, and the first postfix with the first query into a first group designating one or more prefixes and one or more postfixes as being associated with the first type;
identifying a second named entity associated the first prefix and the first postfix; and
at least one of:
responsive to the second named entity comprising the first type, adding a first search intent case, comprising the first prefix, the first postfix, and the first type, to a database; or
responsive to the second named entity comprising a second type:
removing the first prefix and the first postfix from the first group; and
grouping the first type, a second prefix, and a second postfix into the first group based upon a second query, comprising the second prefix, the second postfix, and a second named entity associated with the first type.

19. The method of claim 18, comprising:
identifying a first domain of a first search result selected by a first user, associated with the first query, in response to the first query.

20. The method of claim 18, comprising:
responsive to identifying a duplicate search intent case in the database, where the duplicate search intent case is the same as the first search intent case, removing the duplicate search intent case from the database.
